(19) United States
(12) Patent Application Publication
(10) Pub. No.: US 2026/0339063 A1
(43) Pub. Date: Oct. 29, 2026

(54) OPTICAL IMAGING LENS

(71) Applicant: GENIUS ELECTRONIC OPTICAL (XIAMEN) CO., LTD., Xiamen (CN)

(72) Inventors: Yibin Xu, Xiamen (CN); Qingshu Ye, Xiamen (CN); Wensen Chen, Xiamen (CN); Feng Chen, Xiamen (CN)

(73) Assignee: GENIUS ELECTRONIC OPTICAL (XIAMEN) CO., LTD., Xiamen (CN)

(21) Appl. No.: 19/228,767

(22) Filed: Jun. 5, 2025

(30) Foreign Application Priority Data
Apr. 25, 2025 (CN) 202510530634.6

(51) Int. Cl. G02B 7/02; G02B 5/00; G02B 27/00

(52) U.S. Cl. CPC G02B 7/021; G02B 5/005; G02B 7/025; G02B 27/0018

(57) ABSTRACT

An optical imaging lens includes a metal cap, a plastic lens barrel, and a plurality of lens elements arranged in the plastic lens barrel along an optical axis from an object side to an image side. The plastic lens barrel includes a fixing surface facing the object side and a light-through portion close to the object side. One of the lens elements closest to the object side is a first lens element, and an object side surface of the first lens element is located between the object side and the fixing surface. The metal cap is arranged on the fixing surface and forms a light-through aperture. There is a clearance gap between the light-through portion and the first lens element.

### CROSS-REFERENCE TO RELATED APPLICATION

This application claims the priority benefit of China application serial no. 202510530634.6, filed on Apr. 25, 2025. The entirety of the above-mentioned patent application is hereby incorporated by reference herein and made a part of this specification.

### BACKGROUND

### Technical Field

The disclosure relates to an optical element, and particularly relates to an optical imaging lens.

### Related Art

The specifications of portable electronic products are constantly evolving, and the key components thereof—optical imaging lenses—are also developing in increasingly diverse ways, in which the front camera of mobile phones in the market is gradually trending toward being fully embedded within the screen, and thus the demand for a more compact lens head design has become increasingly intense.

Due to the optical parameter requirements (F/NO, EFL, and aperture size) in lens design and the molding limitations of plastic lens barrels, it is difficult to achieve miniaturization of the lens head using conventional lens barrel designs. Meanwhile, miniaturization often brings problems that need to be solved, such as stray light generation and high assembly difficulty. In current technology, if a one-piece plastic lens barrel is used, the front end wall thickness forming limitation is approximately ≥0.20 mm, making it impossible to achieve a thinner design, and thin plastic may lead to insufficient structural strength due to the mechanical properties thereof. Although retracting the lens barrel head and applying a light-shielding coating directly on the exposed edge surface of the optical lens can significantly reduce the head size, the actual coating range may deviate from the ideal design due to capillary effects influenced by the roughness of the lens frosted surface, which may also cause problems such as detachment, damage, or even deterioration due to environmental influences. Therefore, how to design an ultra-small head size optical imaging lens that can block stray light, enhance assembly convenience, and have good reliability is a problem that the industry currently needs to solve.

### SUMMARY

The disclosure provides an optical imaging lens that can block stray light, enhance assembly convenience, and have good reliability with an ultra-small head size, while overcoming coating reliability issues of related art.

The disclosure provides an optical imaging lens, which includes a metal cap, a plastic lens barrel, and a plurality of lens elements arranged in the plastic lens barrel along an optical axis from an object side to an image side. The plastic lens barrel includes a fixing surface facing the object side and a light-through portion close to the object side. One of the lens elements closest to the object side is a first lens element, and an object side surface of the first lens element is located between the object side and the fixing surface. The metal cap is arranged on the fixing surface and forms a light-through aperture. There is a clearance gap between the light-through portion and the first lens element. The optical imaging lens satisfies conditions as follows: 0.400≤(Dcmax−Dbo)/(Dcmax−D1min)≤1.000 and 1.000≤Dco/D1min≤1.100, in which Dcmax is a maximum outer diameter of the metal cap, Dbo is an inner diameter of the light-through portion closest to the object side, D1min is a minimum outer diameter of the first lens element closest to the object side, and Dco is an outer diameter of the metal cap closest to the object side.

In an embodiment of the disclosure, the optical imaging lens satisfies a condition as follows: 0.450≤(Dcmax−Dbo)/(Dcmax−Dci)≤1.000, in which Dci is an outer diameter of a side wall portion of the metal cap closest to the image side.

In an embodiment of the disclosure, the optical imaging lens satisfies a condition as follows: 1.200≤Dcmax/Dbo≤1.550.

In an embodiment of the disclosure, the optical imaging lens satisfies a condition as follows: 0.450≤(Dcmax−Dbo)/(Dcmax−D1pmax)≤1.000, in which D1pmax is a maximum outer diameter of the first lens element in an extending direction of the fixing surface.

In an embodiment of the disclosure, the optical imaging lens satisfies a condition as follows: Dco/Dbmax≤0.320, in which Dbmax is a maximum outer diameter of the plastic lens barrel.

In an embodiment of the disclosure, the optical imaging lens satisfies a condition as follows: Dcmax/Dco≥1.600.

In an embodiment of the disclosure, the optical imaging lens satisfies a condition as follows: 0°≤α≤10°, in which α is an included angle between an outer surface of a side wall portion of the metal cap and the optical axis.

In an embodiment of the disclosure, an overall thickness of the metal cap is uniform and equal.

In an embodiment of the disclosure, the optical imaging lens satisfies a condition as follows: 0.024 mm≤Tm≤0.030 mm, in which Tm is a thickness of the metal cap.

In an embodiment of the disclosure, a material of the metal cap includes stainless steel or phosphor bronze.

In an embodiment of the disclosure, the metal cap is adhered to the plastic lens barrel with a thermosetting adhesive.

In an embodiment of the disclosure, the metal cap has a barrel connection surface contacting the fixing surface and an object side plane parallel to the barrel connection surface, and the optical imaging lens satisfies a condition as follows: 0.000 mm≤Pc≤0.005 mm, in which Pc is parallelism between the barrel connection surface and the object side plane.

In an embodiment of the disclosure, a surface of the metal cap is black.

In an embodiment of the disclosure, a surface of the first lens element connecting the clearance gap has a blackening structure.

In an embodiment of the disclosure, the metal cap has a tapered surface at an edge adjacent to the light-through aperture and tapering from the object side to the image side to form the light-through aperture, and the optical imaging lens satisfies a condition as follows: 50°≤β≤60°, in which β is an included angle between the tapered surface extending to the optical axis and the optical axis.

In an embodiment of the disclosure, the metal cap has a tapered surface at an edge adjacent to the light-through aperture, and the tapered surface is an arc surface.

Based on the above, in the optical imaging lens of the disclosure, for miniaturization purposes, the optical imaging lens includes the metal cap, the plastic lens barrel, and the plurality of lens elements arranged the plastic lens barrel along the optical axis from the object side to the image side. The plastic lens barrel includes the fixing surface facing the object side and the light-through portion close to the object side. One of the lens elements closest to the object side is the first lens element, and the object side surface of the first lens element is located between the object side and the fixing surface. Specifically, the outermost object-side portion of the larger volume plastic lens barrel is retracted backward, allowing the first lens element to be exposed from the lens barrel. There is the clearance gap between the light-through portion and the first lens element. The metal cap is arranged on the fixing surface and forms the light-through aperture. Therefore, by shielding with the metal cap, unnecessary light may be prevented from entering the clearance gap, and the exposed portion of the first lens element may be protected, overcoming surface coating reliability issues. Furthermore, the optical imaging lens satisfies the following conditions: 0.400≤(Dcmax−Dbo)/(Dcmax−D1min)≤1.000 and 1.000≤Dco/D1min≤1.100, in which Dcmax is the maximum outer diameter of the metal cap, Dbo is the inner diameter of the light-through portion closest to the object side, D1min is the minimum outer diameter of the first lens element closest to the object side, and Dco is the outer diameter of the metal cap closest to the object side. Therefore, when considering the relationship between the fixing intensity between the cap and the lens barrel and the clearance gap between the light-through portion of the lens barrel and the lens element, when the condition 0.400≤(Dcmax−Dbo)/(Dcmax−D1min)≤1.000 is satisfied, a larger clearance gap is provided, and thus the structural intensity of the light-through portion is increased, and better adhesion is still maintained, making the structure less susceptible to deformation, wear, or detachment from external force, while simultaneously closing the clearance gap to block stray light. Additionally, for the metal cap arranged on the fixing surface, when the condition 1.000≤Dco/D1min≤1.100 is satisfied in terms of a ratio of the outermost object-side outer diameter to the protruding portion outer diameter of the lens element, the radial volume of the head portion can be effectively reduced. The material intensity and ductility of metal are beneficial for manufacturing thin components, allowing for fine-tuning of the shape while maintaining reliability, such as directly forming an aperture stop, which may reduce the assembly of additional miniature components, improve assembly convenience, and reduce the accumulation of assembly tolerances, satisfying coaxiality requirements and increasing lens reliability.

To make the foregoing features and advantages of the disclosure more comprehensible, embodiments are provided below with detailed explanations in conjunction with the accompanying drawings.

### BRIEF DESCRIPTION OF THE DRAWINGS

FIG. 1 is a perspective view of an optical imaging lens according to First Embodiment of the disclosure.

FIG. 2 is a front view of the optical imaging lens in FIG. 1.

FIG. 3 is an exploded perspective view of the optical imaging lens in FIG. 1.

FIG. 4 is a cross-sectional view of the optical imaging lens in FIG. 1.

FIG. 5 is a partially enlarged view of the optical imaging lens in FIG. 4.

FIG. 6 is a cross-sectional view of the optical imaging lens according to Second Embodiment of the disclosure.

FIG. 7 is a cross-sectional view of the optical imaging lens according to Third Embodiment of the disclosure.

FIG. 8 shows the values of various important parameters and the relationships thereof for the optical imaging lens of First Embodiment to Third Embodiment of the disclosure.

### DESCRIPTION OF THE EMBODIMENTS

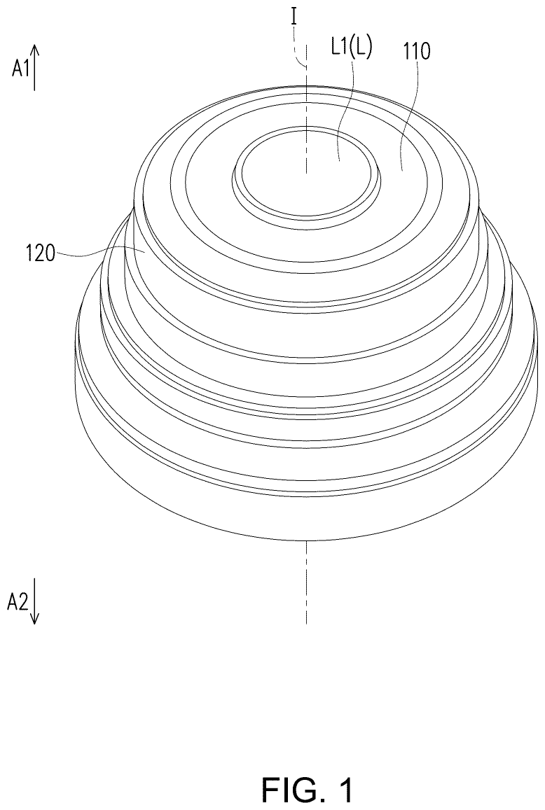

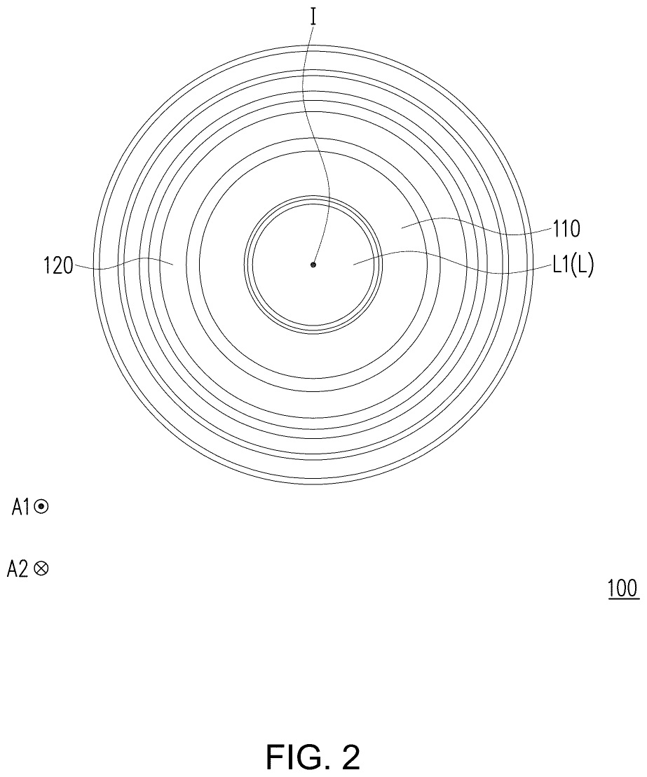

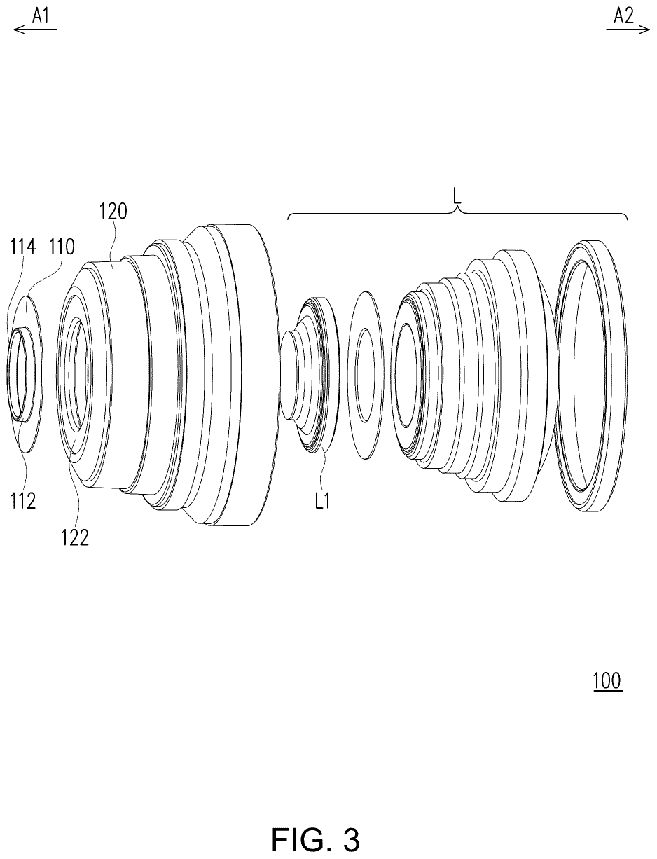

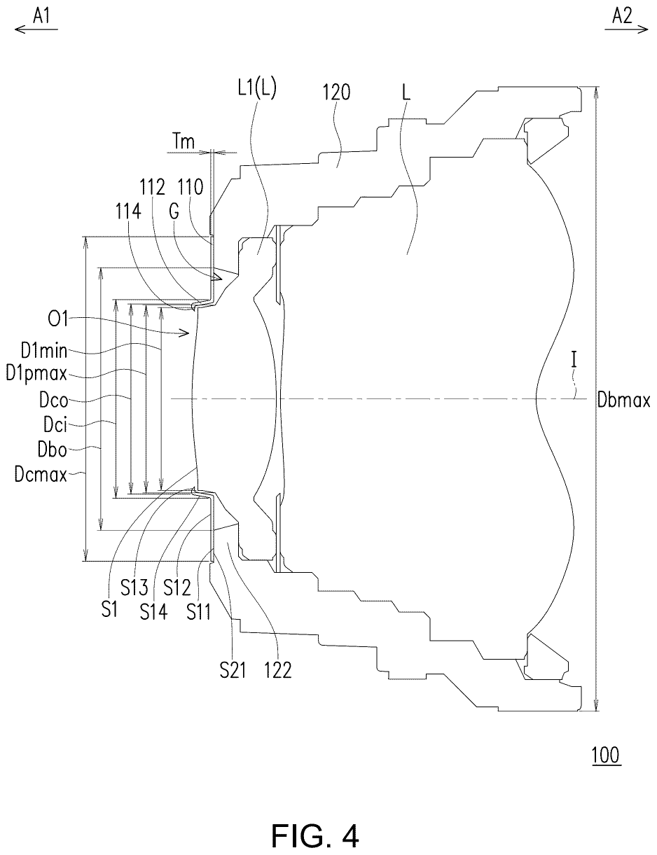

Please refer to FIG. 1 to FIG. 4. This embodiment provides an optical imaging lens 100, which includes a metal cap 110, a plastic lens barrel 120, and multiple lens elements L arranged in the plastic lens barrel 120 along an optical axis I from an object side A1 to an image side A2. It should be noted that, for simplification of the drawings, the detailed structures of the multiple lens elements L are omitted in FIG. 4. When light emitted from an object to be photographed enters the optical imaging lens 100 and passes through the multiple lens elements L and a filter, an image is formed on an image plane. In all embodiments disclosed herein, the number, surface shape, material, and type of the multiple lens elements L are not limited.

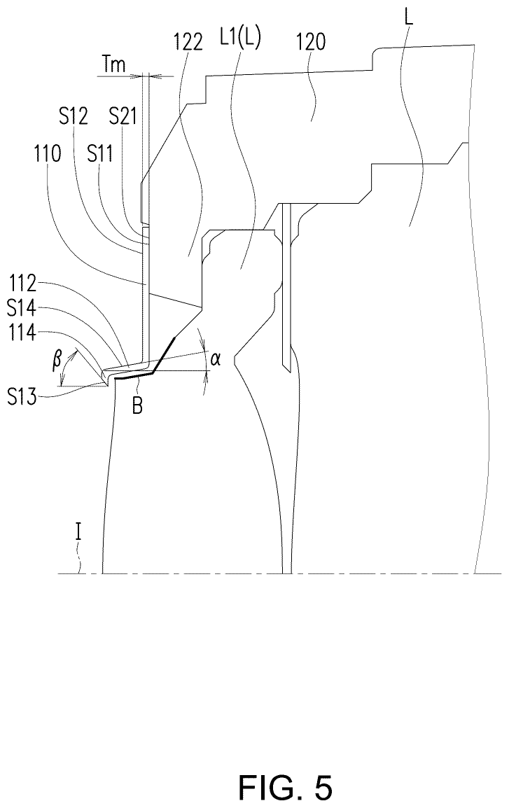

The plastic lens barrel 120 includes a fixing surface S21 facing the object side A1 and a light-through portion 122 close to the object side A1. One of the multiple lens elements L closest to the object side A1 is a first lens element L1, and an object side surface S1 of the first lens element L1 is located between the object side A1 and the fixing surface S21. In this way, the larger volume plastic lens barrel 120 may be designed to retract toward the image side A2, allowing the first lens element L1 to be exposed from the plastic lens barrel 120, thereby achieving miniaturization. Additionally, there is a clearance gap G between the light-through portion 122 of the plastic lens barrel 120 and the first lens element L1, and the surface of the first lens element L1 connecting the clearance gap G has a blackening structure, such as a coating or ink (as shown by a blackening structure B in FIG. 5). This way, the characteristic is beneficial for blocking or absorbing stray light, reducing stray light entering the optically effective area. The clearance gap G may avoid assembly interference between the plastic lens barrel 120 and the blackening structure B, reducing coaxiality issues.

FIG. 5 is a partially enlarged view of the optical imaging lens in FIG. 4. Please refer to FIG. 4 and FIG. 5 simultaneously. The metal cap 110 is arranged on the fixing surface S21 of the plastic lens barrel 120 and forms a light-through aperture O1. The metal cap 110 has a barrel connection surface S11 contacting the fixing surface S21 of the plastic lens barrel 120 and an object side plane S12 parallel to the barrel connection surface S11. Therefore, the exposed portion of the first lens element L1 may be shielded and protected by the metal cap 110, overcoming coating reliability issues. Specifically, the metal cap 110 includes a side wall portion 112 bent toward the object side A1 and a chamfer portion 114 located at an end of the side wall portion 112 toward the object side A1 and bent toward the optical axis I. In this embodiment, the metal cap 110 has a tapered surface S13 (that is, the surface of the chamfer portion 114 toward the optical axis I) at an edge adjacent to the light-through aperture O1. Therefore, the configuration is beneficial for reflecting stray light, reducing stray light entering the optically effective area. In a preferred embodiment, the tapered surface S13 is an arc surface.

In addition, the material of the metal cap 110 is metal, which has material strength and ductility beneficial for manufacturing thin components, allowing for fine-tuning of the shape while maintaining reliability, such as directly forming an aperture stop, which may reduce the assembly of additional miniature components. In this embodiment, the overall thickness of the metal cap 110 is uniform and equal. Therefore, the characteristic is beneficial for improving assembly precision and manufacturing convenience. In this embodiment, the material of the metal cap 110 includes stainless steel or phosphor bronze. Therefore, the material is beneficial for the durability and corrosion resistance of the metal cap 110, with good mechanical properties that also facilitate processing. In this embodiment, the surface of the metal cap 110 is black. Therefore, the characteristic is beneficial for blocking or absorbing stray light, reducing stray light entering the optically effective area. In this embodiment, during assembly, the metal cap 110 is adhered to the plastic lens barrel 120 with a thermosetting adhesive. As a result, adhesion may be enhanced without requiring the use of ultraviolet light.

In the optical imaging lens 100 of First Embodiment, a thickness Tm of the metal cap 110 is 0.024 mm, an included angle α between the outer surface S14 of the side wall portion 112 of the metal cap 110 and the optical axis I is 10°, and an included angle β between the tapered surface S13 of the metal cap 110 extending to the optical axis I and the optical axis I is 50°.

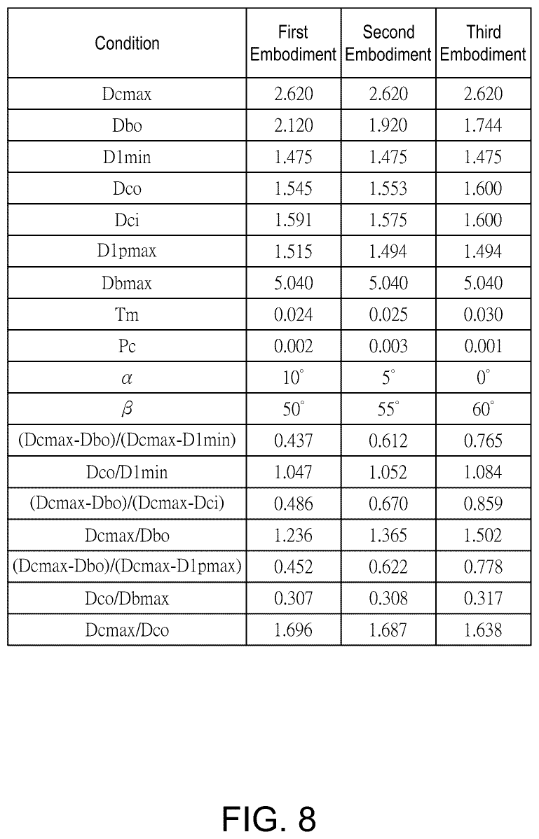

In addition, the relationships between the important parameters in the optical imaging lens 100 of First Embodiment are shown in FIG. 8.

In the embodiment,
Dcmax is the maximum outer diameter of the metal cap 110;
Dbo is the inner diameter of the light-through portion 122 of the plastic lens barrel 120 closest to the object side A1;
D1min is the minimum outer diameter of the first lens element L1 closest to the object side A1;
Dco is the outer diameter of the metal cap 110 closest to the object side A1;
Dci is the outer diameter of the side wall portion 112 of the metal cap 110 closest to the image side A2;
D1pmax is the maximum outer diameter of the first lens element L1 in an extending direction of the fixing surface S21 of the plastic lens barrel 120;
Dbmax is the maximum outer diameter of the plastic lens barrel 120;
Tm is the thickness of the metal cap 110;
Pc is parallelism between the barrel connection surface S11 and the object side plane S12 of the metal cap 110;
α is the included angle between an outer surface S14 of the side wall portion 112 of the metal cap 110 and the optical axis I; and
β is the included angle between the tapered surface S13 of the metal cap 110 extending to the optical axis I and the optical axis I.

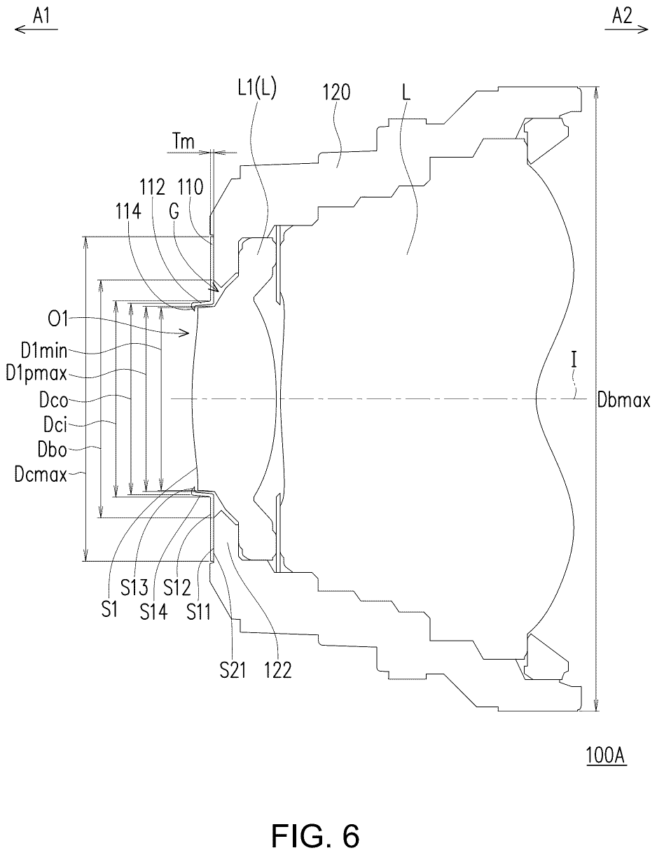

FIG. 6 is a cross-sectional view of the optical imaging lens according to Second Embodiment of the disclosure. Referring to FIG. 6, Second Embodiment of an optical imaging lens 100A of the disclosure is substantially similar to the optical imaging lens 100 of First Embodiment, and the differences between the two are described as follows: the optical data, structural parameters between the metal cap 110 and the plastic lens barrel 120 are more or less different.

In the optical imaging lens 100A of Second Embodiment, the thickness Tm of the metal cap 110 is 0.025 mm, the included angle α between the outer surface S14 of the side wall portion 112 of the metal cap 110 and the optical axis I is 5°, and the included angle β between the tapered surface S13 of the metal cap 110 extending to the optical axis I and the optical axis I is 55°.

In addition, the relationships between the important parameters in the optical imaging lens 100A of Second Embodiment are shown in FIG. 8.

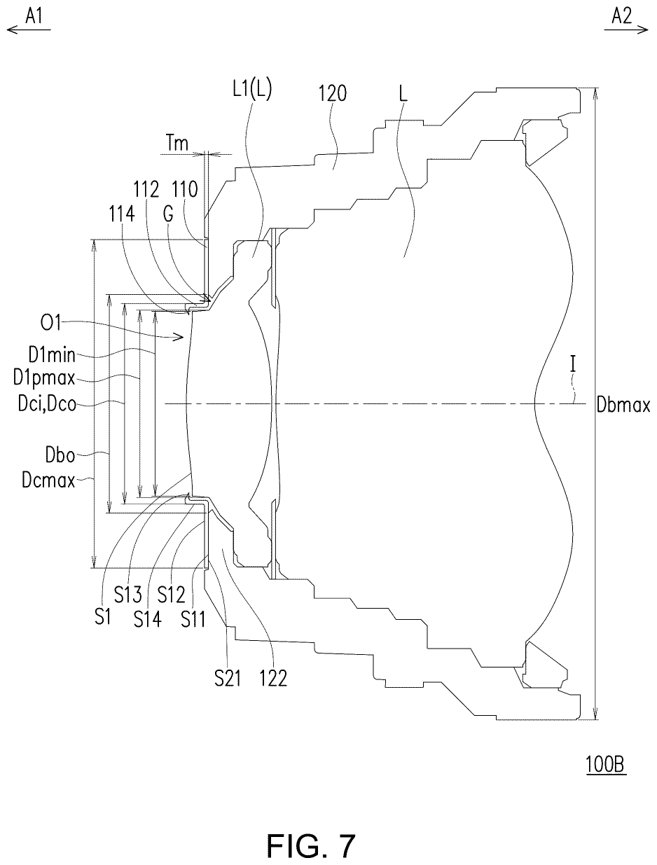

FIG. 7 is a cross-sectional view of the optical imaging lens according to Third Embodiment of the disclosure. Referring to FIG. 7, Third Embodiment of an optical imaging lens 100B of the disclosure is substantially similar to the optical imaging lens 100 of First Embodiment, and the differences between the two are described as follows: the optical data, structural parameters between the metal cap 110 and the plastic lens barrel 120 are more or less different.

In the optical imaging lens 100B of Third Embodiment, the thickness Tm of the metal cap 110 is 0.030 mm, the included angle α between the outer surface S14 of the side wall portion 112 of the metal cap 110 and the optical axis I is 0°, and the included angle β between the tapered surface S13 of the metal cap 110 extending to the optical axis I and the optical axis I is 60°.

In addition, the relationships between the important parameters in the optical imaging lens 100B of Third Embodiment are shown in FIG. 8.

In addition, in each of the embodiments, when considering the relationship between the fixing intensity between the metal cap 110 and the plastic lens barrel 120 and the clearance gap G between the light-through portion 122 of the plastic lens barrel 120 and the first lens element L1, when the optical imaging lens 100, 100A, 100B satisfy the condition 0.400≤(Dcmax−Dbo)/(Dcmax−D1min)≤1.000, a larger clearance gap is provided, and thus the structural intensity of the light-through portion is increased, and better adhesion is still maintained, making the structure less susceptible to deformation, wear, or detachment from external force, while simultaneously closing the clearance gap G to block stray light. In a preferred embodiment, the optical imaging lens 100, 100A, 100B satisfy the condition 0.430≤(Dcmax−Dbo)/(Dcmax−D1min)≤0.800, but the disclosure is not limited thereto.

In addition, in each of the embodiments, for the metal cap 110 arranged on the fixing surface S21 of the plastic lens barrel 120, when the condition 1.000≤Dco/D1min≤1.100 is satisfied in terms of a ratio of the outer diameter closest to the object side A1 to the minimum outer diameter of the protruding portion of the first lens element L1, the radial volume of the head portion of the optical imaging lens 100 can be effectively reduced. In a preferred embodiment, the optical imaging lens 100, 100A, 100B satisfy the condition 1.040≤Dco/D1min≤1.090, but the disclosure is not limited thereto.

In addition, in each of the embodiments, when the optical imaging lens 100, 100A, 100B satisfy the following conditions: 0.450≤(Dcmax−Dbo)/(Dcmax−Dci)≤1.000, 1.200≤Dcmax/Dbo≤1.550, and 0.450≤(Dcmax−Dbo)/(Dcmax−D1pmax)≤1.000, the condition is beneficial to maintain better adhesion under the situation with a larger clearance gap G, making the structure less susceptible to deformation, wear, or detachment from external force, while simultaneously closing the clearance gap G to block stray light. In a preferred embodiment, the optical imaging lens 100, 100A, 100B satisfy the conditions 0.480≤(Dcmax−Dbo)/(Dcmax−Dci)≤0.900, 1.230≤Dcmax/Dbo≤1.510, and 0.450≤(Dcmax−Dbo)/(Dcmax−D1pmax)≤0.800, but the disclosure is not limited thereto.

In addition, in each of the embodiments, when the optical imaging lens 100, 100A, 100B satisfy the following condition: Dco/Dbmax≤0.320, when the overall volume of the plastic lens barrel 120 is larger, the thin metal cap 110 is beneficial for minimizing the radial volume of the front head portion as much as possible. In a preferred embodiment, the optical imaging lens 100, 100A, 100B satisfy the condition 0.300≤Dco/Dbmax≤0.320, but the disclosure is not limited thereto.

In addition, in each of the embodiments, when the optical imaging lens 100, 100A, 100B satisfy the following condition: Dcmax/Dco≥1.600, the reduction of the outermost object-side outer diameter of the metal cap 110 is beneficial for reducing the head portion volume of the optical imaging lens 100, 100A, 100B, while having the image-side diameter of the metal cap 110 as close as possible to the object-side diameter of the plastic lens barrel 120 is beneficial for increasing the adhesion intensity by having a larger contact surface with the plastic lens barrel 120. In a preferred embodiment, the optical imaging lens 100, 100A, 100B satisfy the condition 1.630≥Dcmax/Dco≥1.700, but the disclosure is not limited thereto.

In addition, in each of the embodiments, when the optical imaging lens 100, 100A, 100B satisfy the following condition: 0°≤α≤10°, the condition is beneficial for adapting to designs of various lens elements in combination with the plastic lens barrel 120, to achieve the purpose of ultra-small head.

In addition, in each of the embodiments, when the optical imaging lens 100, 100A, 100B satisfy the following condition: 0.024 mm≤Tm≤0.030 mm, the condition is beneficial for reducing the head portion volume of the optical imaging lens 100, 100A, 100B.

In addition, in each of the embodiments, when the optical imaging lens 100, 100A, 100B satisfy the following condition: 0.000 mm≤Pc≤0.005 mm, the condition is beneficial for improving assembly precision. In a preferred embodiment, the optical imaging lens 100, 100A, 100B satisfy the condition 0.000 mm≤Pc≤0.003 mm, but the disclosure is not limited thereto.

In addition, in each of the embodiments, when the optical imaging lens 100, 100A, 100B satisfy the following condition: 50°≤β≤60°, the condition is beneficial for reflecting stray light, reducing the stray light entering the optically effective area.

In summary, in the optical imaging lens of the disclosure, for miniaturization purposes, the optical imaging lens includes the metal cap, the plastic lens barrel, and the plurality of lens elements arranged the plastic lens barrel along the optical axis from the object side to the image side. The plastic lens barrel includes the fixing surface facing the object side and the light-through portion close to the object side. One of the lens elements closest to the object side is the first lens element, and the object side surface of the first lens element is located between the object side and the fixing surface. Specifically, the outermost object-side portion of the larger volume plastic lens barrel is retracted backward, allowing the first lens element to be exposed from the lens barrel. There is the clearance gap between the light-through portion and the first lens element. The metal cap is arranged on the fixing surface and forms the light-through aperture. Therefore, by shielding with the metal cap, unnecessary light may be prevented from entering the clearance gap, and the exposed portion of the first lens element may be protected, overcoming surface coating reliability issues. Furthermore, the optical imaging lens satisfies the following conditions: 0.400≤(Dcmax−Dbo)/(Dcmax−D1min)≤1.000 and 1.000≤Dco/D1min≤1.100, in which Dcmax is the maximum outer diameter of the metal cap, Dbo is the inner diameter of the light-through portion closest to the object side, D1min is the minimum outer diameter of the first lens element closest to the object side, and Dco is the outer diameter of the metal cap closest to the object side. Therefore, when considering the relationship between the fixing intensity between the cap and the lens barrel and the clearance gap between the light-through portion of the lens barrel and the lens element, when the condition 0.400≤(Dcmax−Dbo)/(Dcmax−D1min)≤1.000 is satisfied, a larger clearance gap is provided, and thus the structural intensity of the light-through portion is increased, thereby better adhesion is maintained, making the structure less susceptible to deformation, wear, or detachment from external force, while simultaneously closing the clearance gap to block stray light. Additionally, for the metal cap arranged on the fixing surface, when the condition 1.000≤Dco/D1min≤1.100 is satisfied in terms of a ratio of the outermost object-side outer diameter to the protruding portion outer diameter of the lens element, the radial volume of the head portion can be effectively reduced. The material intensity and ductility of metal are beneficial for manufacturing thin components, allowing for fine-tuning of the shape while maintaining reliability, such as directly forming an aperture stop, which may reduce the assembly of additional miniature components, improve assembly convenience, and reduce the accumulation of assembly tolerances, satisfying coaxiality requirements and increasing lens reliability.

Although the disclosure has been disclosed in the embodiments as above, the embodiments are not intended to limit the disclosure. Persons having ordinary knowledge in the technical field may make some changes and modifications without departing from the spirit and scope of the disclosure. Therefore, the protection scope of the disclosure shall be defined by the appended claims.

What is claimed is:

1. An optical imaging lens, comprising a metal cap, a plastic lens barrel, and a plurality of lens elements arranged in the plastic lens barrel along an optical axis from an object side to an image side, wherein
the plastic lens barrel comprises a fixing surface facing the object side and a light-through portion close to the object side,
one of the lens elements closest to the object side is a first lens element, and an object side surface of the first lens element is located between the object side and the fixing surface,
the metal cap is arranged on the fixing surface and forms a light-through aperture,
there is a clearance gap between the light-through portion and the first lens element, and
the optical imaging lens satisfies conditions as follows: 0.400≤(Dcmax−Dbo)/(Dcmax−D1min)≤1.000 and 1.000≤Dco/D1min≤1.100, wherein Dcmax is a maximum outer diameter of the metal cap, Dbo is an inner diameter of the light-through portion closest to the object side, D1min is a minimum outer diameter of the first lens element closest to the object side, and Dco is an outer diameter of the metal cap closest to the object side.

2. The optical imaging lens as claimed in claim 1, wherein the optical imaging lens satisfies a condition as follows: 0.450≤(Dcmax−Dbo)/(Dcmax−Dci)≤1.000, wherein Dci is an outer diameter of a side wall portion of the metal cap closest to the image side.

3. The optical imaging lens as claimed in claim 1, wherein the optical imaging lens satisfies a condition as follows: 1.200≤Dcmax/Dbo≤1.550.

4. The optical imaging lens as claimed in claim 1, wherein the optical imaging lens satisfies a condition as follows: 0.450≤(Dcmax−Dbo)/(Dcmax−D1pmax)≤1.000, wherein D1pmax is a maximum outer diameter of the first lens element in an extending direction of the fixing surface.

5. The optical imaging lens as claimed in claim 1, wherein the optical imaging lens satisfies a condition as follows: Dco/Dbmax≤0.320, wherein Dbmax is a maximum outer diameter of the plastic lens barrel.

6. The optical imaging lens as claimed in claim 1, wherein the optical imaging lens satisfies a condition as follows: Dcmax/Dco≥1.600.

7. The optical imaging lens as claimed in claim 1, wherein the optical imaging lens satisfies a condition as follows: 0°≤α≤10°, wherein α is an included angle between an outer surface of a side wall portion of the metal cap and the optical axis.

8. The optical imaging lens as claimed in claim 1, wherein an overall thickness of the metal cap is uniform and equal.

9. The optical imaging lens as claimed in claim 1, wherein the optical imaging lens satisfies a condition as follows: 0.024 mm≤Tm≤0.030 mm, wherein Tm is a thickness of the metal cap.

10. The optical imaging lens as claimed in claim 1, wherein a material of the metal cap comprises stainless steel or phosphor bronze.

11. The optical imaging lens as claimed in claim 1, wherein the metal cap is adhered to the plastic lens barrel with a thermosetting adhesive.

12. The optical imaging lens as claimed in claim 1, wherein the metal cap has a barrel connection surface contacting the fixing surface and an object side plane parallel to the barrel connection surface, and the optical imaging lens satisfies a condition as follows: 0.000 mm≤Pc≤0.005 mm, wherein Pc is parallelism between the barrel connection surface and the object side plane.

13. The optical imaging lens as claimed in claim 1, wherein a surface of the metal cap is black.

14. The optical imaging lens as claimed in claim 1, wherein a surface of the first lens element connecting the clearance gap has a blackening structure.

15. The optical imaging lens as claimed in claim 1, wherein the metal cap has a tapered surface at an edge adjacent to the light-through aperture and tapering from the object side to the image side to form the light-through aperture, and the optical imaging lens satisfies a condition as follows: 50°≤β≤60°, wherein β is an included angle between the tapered surface extending to the optical axis and the optical axis.

16. The optical imaging lens as claimed in claim 1, wherein the metal cap has a tapered surface at an edge adjacent to the light-through aperture, and the tapered surface is an arc surface.
